(19) United States
(12) Patent Application Publication
(10) Pub. No.: US 2016/0138565 A1
(43) Pub. Date: May 19, 2016

(54) WIND TURBINE FOR ELECTRIC VEHICLE

(71) Applicant: Gevorg Serezaevih Noroian, Moscow (RU)

(72) Inventor: Gevorg Serezaevih Noroian, Moscow (RU)

(21) Appl. No.: 14/898,756

(22) PCT Filed: Jun. 19, 2014
(86) PCT No.: PCT/EA2014/000015

§ 371 Date: Dec. 16, 2015

(30) Foreign Application Priority Data
Jun. 24, 2013 (RU) 2013128924

(51) Int. Cl. F03D 3/06; F03D 9/00; B60L 8/00; F03D 3/04

(52) U.S. Cl. CPC F03D 3/062; F03D 3/0436; F03D 9/002; F03D 11/02; B60L 8/006

(57) ABSTRACT

The invention relates to mechanical engineering and can be applied to the modernization of electric vehicles in order to conserve energy while in motion. An electric vehicle wind generator, containing a cylindrical chamber having wind wheels positioned therein. A shaft can be installed vertically, horizontally, or at any angle. The shaft is provided with a disk and the disk is provided with blades; the blades consist of a support beam, which is affixed to the disk, and of wings which are installed onto the beam with the help of arcs; a plurality of arcs is installed on each blade in accordance with the width and length of the blade; the arcs on the support beam can rotate, changing the angle of the wings relative to a base; the arcs are affixed by means of clamping bolts, the height of the arcs depends on the size of the turbine, and the arcs are installed beginning from the end of the blade; the base of the turbine is the component on which the turbine is installed. A small space, an air fairing, exists between the turbine and the base. The wider the blades, the larger the fairing distances between them, wherein without the fairing, an air lock is created, decreasing the efficiency of the turbine. The invention provides for an increase in the operating area of the turbine, and also for the possibility of installing the turbine on any components and assemblies.

### CROSS-REFERENCE TO RELATED APPPLICATION

This present application is a national stage patent application of PCT/EA2014/000015 filed on Jun. 19, 2014. The earliest priority filing date claimed is Jun. 24, 2013.

### FEDERALLY SPONSORED RESEARCH

Not Applicable

### SEQUENCE LISTING OR PROGRAM

Not Applicable

The invention relates to mechanical engineering, and specifically to a wind turbine for an electric vehicle, and can be used for accessorizing or modifying the electric vehicle.

A pyramidal wind motor for a vehicle contains a wind intake. The wind intake is configured in the form of a convergent channel and connected to an air duct. The air stream of the headwind flows into a cylinder-shaped chamber in which a wind turbine is installed. The air stream then flows into an air conduit in the form of twin hoses that exit at both sides of the vehicle. The used air stream exits from these hoses into the atmosphere and creates an aerodynamic effect by virtue of the air being sucked out of the hoses. A generator is arranged outside the cylinder-shaped chamber (Patent UA 17750 2009. http:www.altenerg.ru/energiya-iobovogo-vozdushnogo-potoka/).

The shortcomings of the known invention are a complicated design and low aerodynamic efficiency. Furthermore, directing the entire headwind into one or two turbines is inexpedient.

The closest prior art to the present invention is a ship with a wind motor, which contains vanes attached to a shaft. The vanes are half-covered with protective shielding. On the lower end of the shaft a clutch is fastened, which transfers motion.

The shortcoming of this prototype is a small working surface of the turbine.

The essence of the present invention is the ability to charge the battery while driving, which is achieved by headwinds using a turbine with an enlarged working surface. The technical effect of the claimed invention is an enlargement of the turbine working surface, expedient and economical manufacturing, and of the ability to mount the mechanism on any components of any machine unit of the electric vehicle. The turbine for an electric vehicle consists of a shaft, which is equipped with a disc on one side and a gear, or traction sheave, on the other side in order to transfer motion to a generator. The generator can also be configured as a built-in generator. The shaft can be positioned upright as well as horizontally, or also inclined at any angle. Turbine blades are attached to the disc. The turbine blades consist of a support structure, which is fastened onto the disc. An upper vane is mounted on the support structure using curved elements. The curved elements as well as the upper vanes are made of a flat, elastic material. The curved element length coincides with the upper vane width at the installation site of the curved elements. The curved elements are thus perpendicular to the upper vanes. The curved elements simultaneously act as stiffening ribs. The turbine blades are connected to support structures by the curved elements and receive a considerable portion of the wind pressure. With their help, the wind stream is conducted into an anterior section. On each turbine blade, certain curved elements are constructed in relation to the width and length of each turbine blade such that they cover one another when viewed from the headwind side. The curved elements arranged on the support structure are rotatable, wherein the angle of the upper vanes to a mount and to the air stream capture is alterably configured. The curved elements are fastened with clamping screws. The height of the curved elements depends upon the size of the turbine. The curved elements on a turbine blade can thus be variable, for example, increasing from the center point or vice versa. In order to increase the efficiency of the turbine, the curved elements are formed from the end point of the turbine blade and toward the center point such that they cover one another when viewed from the wind side.

A component of the electric vehicle on which the turbine is set is viewed as a mount for the turbine. Between the turbine and the mount, there is a small space which serves as an air deflector for the passage of air. The wider the turbine blades are, the greater the distance between the turbine blades. The last curved element is arranged at the very end of the turbine blade. A part of the turbine that turns against the wind is fitted into the component on which this turbine part is installed. This turbine part is covered by a guide vane, which simultaneously directs the wind stream to the working part of the turbine. The number of turbine blades may vary, but must be at least three. The more turbine blades that are present, the greater the effectiveness of the mechanism. To increase the efficiency of the turbine, the turbine blades are configured to overlap one another, thus increasing the working surface of the turbine. Numerous turbines can be arranged on an electric vehicle. In doing so, the turbines can be mounted on any component or on any assembly that the wind can strike. Moreover, the electric vehicle can also be charged while stationary when there is wind if it is parked facing the wind.

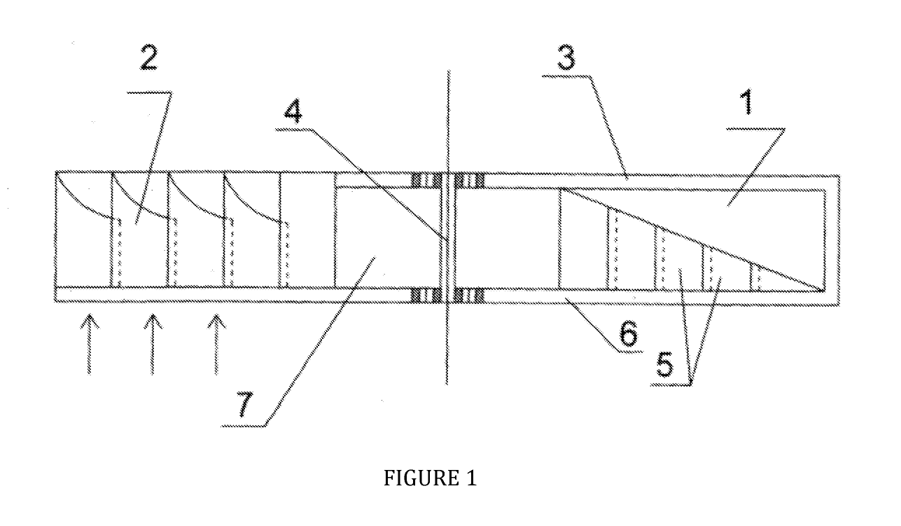

The invention will be explained in more detail, with reference to an exemplary embodiment illustrated in the FIG. 1.

The electric vehicle is started with the aid of electrical energy storage units. The wind turbines operate while driving due to the headwind. The air stream captured by vanes 1 is conducted to the mount 3 of the turbine. Curved elements 2 conduct the air stream in a circle via an air duct 5 into the anterior section, thus building up pressure therein. In this manner the air stream from each subsequent turbine blade enters each section, and the air streams continuously from the turbine in the wind flow direction until the turbine has completed half a turn. A support structure 6 is rigidly connected to a shaft 4. A generator 7 generates electric current and provides the electric energy reserve, wherein power generation can exceed current consumption many times over during downhill travel.

1. A wind turbine for an electric vehicle, with a cylinder-shaped wind receiving chamber, characterized in
that a shaft (4) is arranged upright, horizontally, or inclined at any angle on a disc,
that turbine blades (1) are installed, wherein each turbine blade (1) is arranged on a support structure (6), which is fastened to the disc on which upper vanes are formed by curved elements (2),
that a few curved elements (2) are fitted on each turbine blade (1) in relation to the width and length of the turbine blade in such a way that the curved elements (2) partially overlap one another when viewed from the direction of wind blowing,
that the curved elements (2) arranged on the support structure (6) are rotatable, whereby the angle of the upper vanes is configured as alterable in relation to a mount (3) and to the air flow capture,
that the curved elements are fastened with clamping screws,
that the height of the curved elements depends upon the size of the turbine,
that the curved elements on a turbine blade are variable, increasing from the middle point or vice versa,
that the curved elements are arranged starting from the end point of the turbine blade,
that the length of the curved elements at their installation site coincides with the upper vane width,
that the curved elements act as stiffening ribs and assume a considerable portion of the wind pressure,
that a component on which the turbine is set serves as a mount for the turbine,
that between the turbine and the mount a small space is provided that acts as an air deflector in such a way that the wider the turbine blades are configured, the greater the air deflector height is dimensioned,
that each part of the turbine that turns against the wind is fitted into the component,
that the number of turbine blades is also variable, and
that when viewed from above, the turbine blades partially cover one another in order to increase their working surface.
